(19) United States
(12) Patent Application Publication
(10) Pub. No.: US 2007/0130601 A1
(43) Pub. Date: Jun. 7, 2007

(54) Internet protocol (IP) television

(76) Inventors: Weiping Li, Palo Alto, CA (US); Cherng-Daw Hwang, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/294,186

(22) Filed: Dec. 5, 2005

(51) Int. Cl. H04N 7/173

(52) U.S. Cl. 725/112; 725/113

(57) ABSTRACT

Embodiments are directed to systems and methods for delivering broadcast television (TV) using an Internet Protocol (IP) network. The IPTV system and methods use real-time routing servers to unicast and/or multicast of broadcast television programs. The IPTV system and methods may enable advertisers to insert local commercials into national or international television broadcasts. The IPTV system and methods offer network-based time-shifting of broadcast television programming rather than personal video recorder (PVR)-based time-shifting. The IPTV system and methods may provide scalable video on-demand (VOD) by multicasting video content and dynamically determining whether to speed up or slow down a bit stream to catch up to or wait for the previous or next multicast of the video content. The IPTV system and methods also may enables interactive television programming whereby a viewer may be permitted to exchange video with a television program and have that video displayed.

### FIELD

Embodiments of the present invention relate to telecommunications and in particular to television (TV) communications.

### BACKGROUND

Broadcast television has proven to be an effective approach to providing multimedia content. This is especially true when sending content to a large audience because the same content can be sent to millions of viewers at the same time. Broadcast television has limitations, however. One limitation is that a traditional TV broadcasting network (terrestrial, cable, or satellite) uses one-way communication.

One characteristic of current television is that more targeted advertisement has become the trend of television commercials. One current limitation of targeted advertisement is that, local advertisement insertion requires switch of programs at a television head end.

Time-shifting is another feature recently available on broadcast television. Currently, the time-shifted television feature is typically implemented using a personal video recorder (PVR) at the customer home. Many set top box (STB) manufacturers have started to include a PVR function into the STB. This time-shifting technique has limitations as well, however.

Video on-demand (VOD) is a very desirable feature that has been talked about for a long time. The true VOD is for any user to request a video program at any time. Since the server load and the bandwidth usage per video program are proportional to the number of users requesting the same video program, scalability has been the main problem. This is why there have been many trials but few commercial services.

Near VOD (NVOD) is a compromise between providing VOD service and avoiding extremely high bandwidth usage and server load. Basically, NVOD is still broadcast but each program is broadcast with multiple channels at a regularly spaced starting time. For example, a movie of two hours (120 minutes) may be sent through 12 channels with each channel starting the same movie 10 minutes after the previous channel starts. If each channel repeats the same movie after it finishes it, any user at any time can start watching the complete movie with a maximum waiting time of 10 minutes.

There are problems with NVOD as well. First, the user experience is not very good because the “on-demand” part is not truly fulfilled and a user may have to wait for a period of time after making a “demand”. Secondly, the service provider has to guess what video content will be “on-demand” so that a number of channels are allocated for the video content. Since several channels have to be used for a single movie, not many choices can be offered for the NVOD service.

### SUMMARY

A system for delivering television over an Internet Protocol (IP) network (or IPTV) includes a source real-time routing server or a group server that provide a listing of available broadcast television program content to at least one destination real-time routing server. The destination real-time routing server provides this list to at least one end-point device associated with a user. The user sends a request to view a broadcast television program. The source real-time routing server unicasts the requested broadcast television program to the destination real-time routing server and the destination real-time routing server multicasts the requested broadcast television program to the end-point device.

The IPTV system implemented according to embodiments of the present invention may be able to deliver traditional broadcast television programs through an IP network and do it more efficiently than the traditional television broadcasting system. It may supports television broadcasting with efficient bandwidth usage and without relying on IP multicast, but takes advantage of IP multicast wherever possible.

The IPTV system described herein also may remove the limitation of a single service provider and allow cross-offerings between two different service providers to any single user. The IPTV system of this invention also provides an easy way for local advertisement insertion so that more targeted advertisement becomes possible. The IPTV system described herein will implement time-shifted television using a network video recorder rather than a personal video recorder (PVR). In this manner, the cost to users may be lower. The IPTV system of this invention is able to provide scalable video on-demand (VOD) as well as interactive television programming.

Other features and advantages of the present invention will be apparent from the accompanying drawings and from the detailed description that follows.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a simplified block diagram of a communication system according to an embodiment of the present invention;

FIG. 2 is a simplified block diagram of a portion of the IPTV system depicted in FIG. 1 according to an embodiment of the present invention;

FIG. 3 is a flowchart of a process describing operation of the portion of the IPTV system depicted in FIG. 2 according to an embodiment of the present invention;

FIG. 4 is a simplified block diagram of a portion of the IPTV system depicted in FIG. 1 according to an alternative embodiment of the present invention;

FIG. 5 is a simplified block diagram of a portion of the IPTV system depicted in FIG. 1 according to still another embodiment of the present invention;

FIG. 6 is a flowchart illustrating a process for inserting advertisements into a broadcast of a television program according to an embodiment of the present invention;

FIG. 7 is a simplified block diagram of a portion of the IPTV system depicted in FIG. 1 according to an embodiment of the present invention;

FIG. 8 is a simplified block diagram of a portion of the IPTV system depicted in FIG. 1 according to an alternative embodiment of the present invention;

FIG. 9 is a flowchart illustrating a process for time-shifting a broadcast television program according to an embodiment of the present invention;

FIG. 10 is a graphical representation illustrating a process for providing video on-demand according to an embodiment of the present invention;

FIG. 11 is a flowchart illustrating a process for providing video on-demand according to an embodiment of the present invention;

FIG. 12 is a simplified diagram of a television screen layout during viewer interactivity with a broadcast television program according to an embodiment of the present invention;

FIG. 13 is a simplified diagram of a television screen layout during viewer interactivity with a broadcast television program according to an alternative embodiment of the present invention;

FIG. 14 is a simplified diagram of a television screen layout during viewer interactivity with a broadcast television program according to still another embodiment of the present invention;

FIG. 15 is a simplified diagram illustrating latency in the system depicted in FIG. 1 according to an alternative embodiment of the present invention; and

FIG. 16 is a flowchart illustrating a process for permitting viewer interactivity with a broadcast television program according to an embodiment of the present invention.

### DETAILED DESCRIPTION

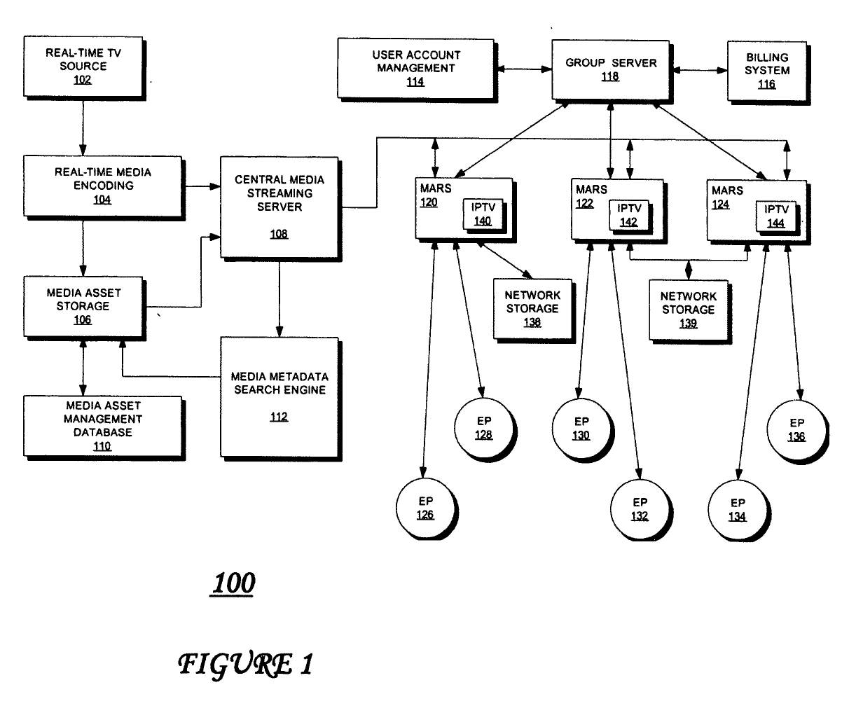

As will be described in more detail below an Internet Protocol television (IPTV) system integrates broadcast television in an Internet Protocol (IP) network. FIG. 1 is a high-level block diagram of an IPTV system 100 according to an embodiment of the present invention. The example system 100 includes a real-time TV source 102 coupled to a real-time media encoding module 104, which is coupled to media asset storage 106 and a central media streaming server 108. A media asset management database 110 is coupled to the media asset storage 106. A media metadata search engine 112 is coupled to the media asset storage 106 and the central media streaming server 108. A user account management module 114 and a billing system 116 are coupled to a group server 118. The group server 118 is coupled to several Multimedia Application Routing Servers (MARS) 120, 122, and 124. The MARS 120 is coupled to two end-point devices 126 and 128, the MARS 122 is coupled to two end-point devices 130 and 132, and the MARS 124 is coupled to two end-point devices 134 and 136. The MARS 120 is coupled to network storage 138. The MARS and 124 are coupled to network storage 139. The central media streaming server 108 is coupled to the group server 118 and to the MARS 120, 122, and 124. The MARS 120 includes an IPTV module 140. The MARS 122 includes an IPTV module 142. The MARS 124 includes an IPTV module 144.

The example IPTV system 100 operates as follows. The real-time TV source 102 provides television programs for the IPTV system 100. The real-time TV source 102 also provides a listing of current and scheduled television programs that are or will be available on each channel in the IPTV system 100. The real-time TV source 102 may in addition offer a short summary or commentary for each program that is listed. The real-time TV source 102 may be a camera in a TV studio, a satellite TV feed, or a video player.

The real-time media encoding module 104 encodes the real-time contents of the real-time TV source 102. The real-time media encoding module 104 also transcodes the video format of the real-time contents of the real-time TV source 102 from one video format to another video format. The real-time media encoding module 104 sends the encoded or transcoded media content to the media asset storage 106 for future on-demand use, for example. The real-time media encoding module 104 also sends the encoded or transcoded media content to the central media streaming server 108.

The media asset storage 106 also provides media content for the IPTV system 100. The media asset storage 106 can be updated with new media content as it becomes available from the real-time TV source 102. The media asset storage 106 may be any suitable non-volatile memory.

The central media streaming server 108 streams media content to the MARS 120, 122, and 124. The central media streaming server 108 can be any suitable server.

The media asset management database 110 determines who can access media content stored in the media asset storage 106. The media asset management module 110 also may determine copyright status, etc.

The media metadata search engine 112 searches for the media content for metadata related to the media content. For example, the media metadata search engine 112 searches for the media content title, media content credits (e.g., producer, director, etc.). The media metadata search engine 112 may be any suitable search engine.

The user account management module 114, the group server 118, the MARS 120, 122, and 124, and the end-point devices 126, 128,130,132, 134, and 136 are used to authenticate users. Only authenticated users will receive media content. For example, the media content traffic information is sent from the MARS 120, 122, and/or 124 to the group server 118. The group server 118 forwards media content traffic information to the billing system 116, which determines whether a user has paid for access to the IPTV system 100 or particular media content. The MARS 120, 122, and/or 124 also perform content monitoring task so that only legitimate contents will be sent to the end-points.

The group server 118 may manage communications sessions over the network of the IPTV system 100. In the group server 118, there may be several software processes running to manage communications among MARS 120, 122, and/or 124, between itself and the user account management module 114, and between itself and the billing system 116. There also may be several software processes running to manage communications with other group servers 118 so that media content provided by various service providers may be shared. The group server 118 may use any suitable operating system, such as the Linux operating system, for example.

MARS 120, 122, and 124 perform transcoding on the media content, if needed, and then send the media content to the end-point devices 126, 128,130,132, 134, and 136. Media content are also sent to the local network storage 138 and/or 139 for caching. An individual MARS 120, 122, and/or 124 may route media content and process media content in real time. Accordingly, the MARS 120, 122, and/or 124 may be referred to herein as a real-time routing server. A MARS 120, 122, and/or 124 may utilize any suitable technique for finding a route for the media content.

An individual end-point device 126, 128,130,132, 134, and/or 136 may be a personal computer (“PC”) running as a software terminal, a dedicated hardware device connection with user interface devices, and/or a combination of a PC and a hardware device. The end-point device 126, 128,130,132, 134, and/or 136 may be used by a human user to make a request to view a broadcast television program and/or video on-demand. The end-point device 126, 128,130,132, 134, and/or 136 may be used by a human user to make a request to PAUSE, REWIND, FAST FORWARD, PLAY, and/or PLAY in SLOW MOTION the broadcast television program. The end-point device 126, 128,130,132, 134, and/or 136 may be used by a human user to make a request to participate interactively in a television show.

The end-point device 126, 128,130,132, 134, and/or 136 may be capable of capturing inputs from user interface devices, such as a video camera, an audio microphone, a pointing device (such as a mouse, for example), a typing device such as a keyboard, for example, and any image/text display on the monitor. The end-point device 126, 128,130,132, 134, and/or 136 also may be capable of sending outputs to user interface devices such as a PC monitor, a TV monitor, a speaker, and an earphone, for example.

The end-point device 126, 128,130,132, 134, and/or 136 may encode and decode multimedia data according to the network bandwidth and the computing power of the particular end-point device. The end-point device 126, 128,130,132, 134, and/or 136 may send encoded media content to its associated MARS, receive encoded media content from its associated MARS, may decode the media content and send the decoded media content to the output devices.

The end-point device 126, 128,130,132, 134, and/or 136 also may process communication messages sent between the end-point device 126, 128,130,132, 134, and/or 136 and their associated MARS. The messages may be related to scheduling delivery of media content, joining a multicast, interactively joining a television show, delivering advertisements, checking the network connection with the MARS, and so on.

The network storage 138 and 140 are any suitable network storage devices that store media content. The network storage 138 and 140 may be Network Attached Storage (NAS) devices, Storage Area Network (SAN) devices, or other suitable storage devices.

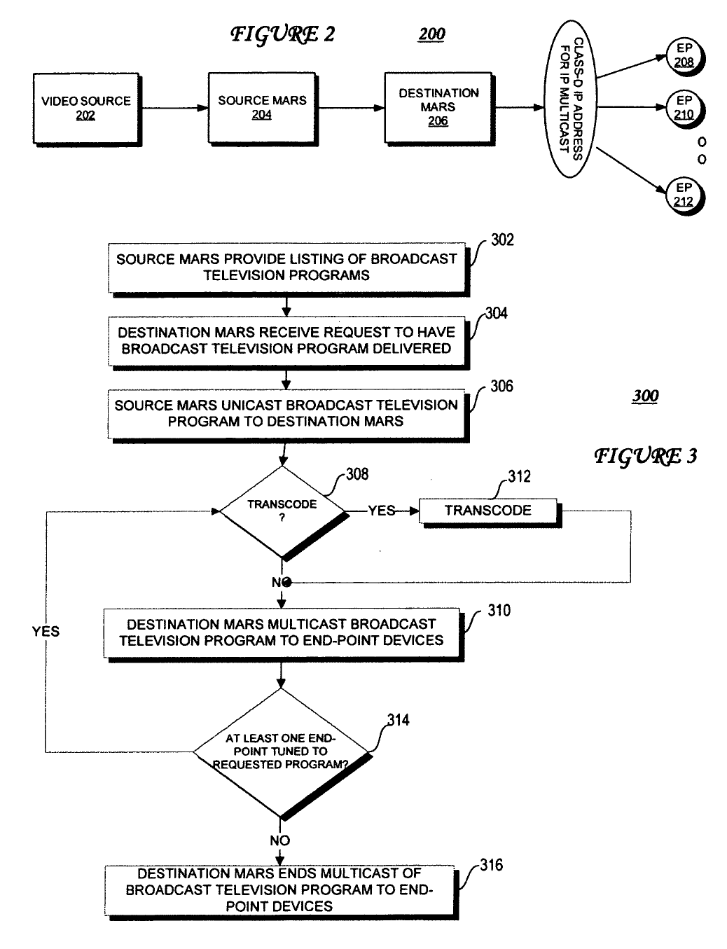

For purposes of illustration suppose that one or more users wish to view a television program. FIG. 2 is a simplified block diagram of a portion 200 of the IPTV system 100 according to an embodiment of the present invention and FIG. 3 is a flowchart of a process 300 describing operation of the portion 200 of the IPTV system 100 according to an embodiment of the present invention. In the illustrated example, the portion 200 includes a video source 202 coupled to a source MARS 204, which is coupled to a destination MARS 206. The destination MARS 206 is coupled to several end-point devices 208, 210, and 212.

The video source 202 may be the real-time TV source 102. The source MARS 204 and/or the destination MARS 206 may be either of the MARS 120, 122, or 124. For some embodiments, the video source 202 provides a listing of broadcast television program content as well as the broadcast television program content itself to the source MARS 204, for example.

In a block 302, the IPTV module in the source MARS 204 receives the listing of broadcast television program content from the video source 202 or group server 118 and provides the listing of broadcast television program content to the IPTV module in the destination MARS 206. The IPTV module in the destination MARS 206 receives the listing of broadcast television program content from the source MARS 204 or group server 118 and provides the listing of the broadcast television program content to the end-point devices 208, 210, and 212.

In a block 304, the IPTV module in the destination MARS 206 receives a request from one or more of the users at the end-point devices 208, 210, and 212 to have a broadcast television program delivered.

In a block 306, the IPTV module in the source MARS 204 receives the broadcast television program from the video source 202 and unicasts the broadcast television program, or a copy thereof, to the IPTV module in the destination MARS 206.

In a block 308, the IPTV module in the destination MARS 206 determines whether the broadcast television program is to be transcoded from one video format/size to another video format/size. If transcoding is not to be performed, then control of the process 300 passes to a block 310 in which the IPTV module in the destination MARS 206 requests a Class D IP address from the group server 118 and multicasts the broadcast television program, or a copy thereof, to the end-point devices 208, 210, and 212 using the Class D IP address.

If in the block 308 the IPTV module in the destination MARS 206 determines that the broadcast television program is to be transcoded from one video format/size to another video format/size, then in a block 312 the IPTV module in the destination MARS 206 transcodes the broadcast television program. Transcoding is performed according to the capability of the receiving end-point devices 208, 210, and 212. For some embodiments, if the capabilities of the end-point devices 208, 210, and 212 are different, the IPTV module in the destination MARS 206 performs multiple transcoding operations for the same input broadcast television program to generate multiple output formats for the different end-point devices 208, 210, and 212.

The end-point devices 208, 210, and/or 212 may utilize a software program, such as any suitable application programming interface (API), for example, to detect its capabilities. Such capabilities may include processor type, processing or computing power, memory type and/or amount, graphics capabilities, audio capabilities, etc., for example. The IPTV module in the destination MARS 206 may store the capabilities of the end-point devices 208, 210, and/or 212.

The IPTV module in the destination MARS 206 may transcode the broadcast television program into different size such as VGA, QVGA, CIF, and QCIF. The destination MARS 206 may not need to process the video data from the source MARS 204 but may forward them to the end-point devices 208, 210, and/or 212. The IPTV module in the destination MARS 206 also may transcode the broadcast television program into one of several coding schemes, such as International Telecommunication Union (ITU) coding standards (H.261, H.263, H.264) or International Organization for Standardization (ISO) coding standards (Moving Picture Expert Group (MPEG) 1, 2, 4) or other national coding standard. After the block 312 is performed, the process 300 returns to the block 310.

In a block 314, the IPTV module in the destination MARS 206 determines whether at least one end-point device 208, 210, and/or 212 is tuned to the requested broadcast television program. If at least one end-point device 208, 210, and/or 212 is tuned to the requested broadcast television program, then the process 300 returns to block 310. If none of end-point devices 208, 210, and 212 is tuned to the requested broadcast television program, then the process 300 passes to a block 316.

In the block 316, IPTV module in the destination MARS 206 ends the multicast of the broadcast television program. The IPTV module in the destination MARS 206 may notify the IPTV module in the source MARS 204 that none of the end-point devices 208, 210, and 212 is tuned to the requested broadcast TV program and the source MARS 204 may instruct the central media streaming server 108 to stop sending the broadcast television program.

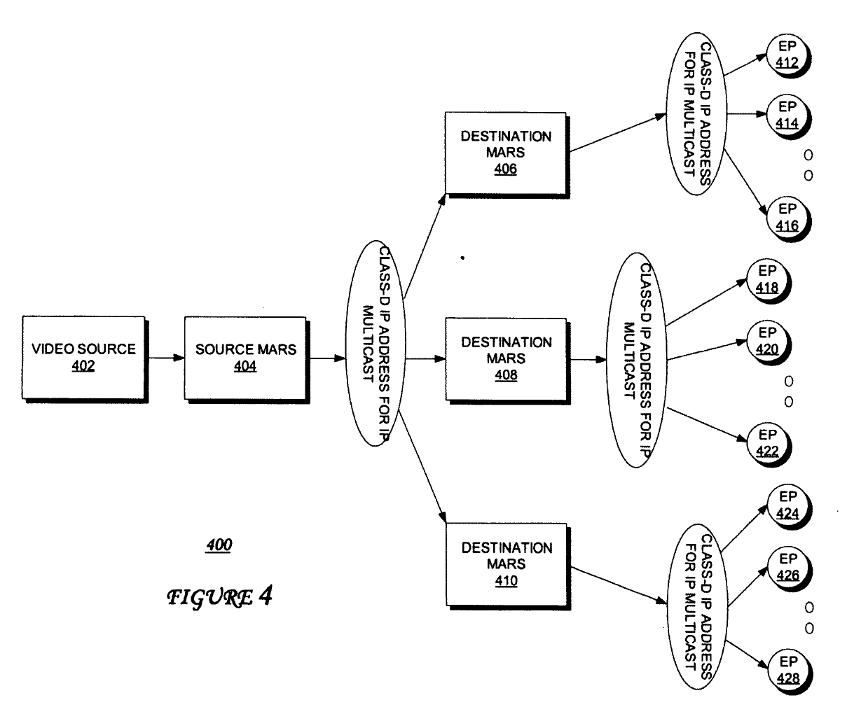

FIG. 4 is a simplified block diagram of a portion 400 of the IPTV system 100 according to an embodiment of the present invention. The example portion 400 operates as follows. The IPTV module in the source MARS 404 receives the listing of broadcast television program content from the video source 402 or group server 118. The IPTV module in the destination MARS 406, 408, and 410 receive the listing of broadcast television program content from the source MARS 404 or group server 118 and provide the listing of the broadcast television program content to the end-point devices 412, 414, 416, 418, 420, 422, 424, 426, and 428. The IPTV module in the destination MARS 406, 408, and/or 410 receive a request from one or more of the users at the end-point devices 412, 414, 416, 418, 420, 422, 424, 426, and 428 to have a broadcast television program delivered. The IPTV module in the source MARS 404 receives the broadcast television program from the video source 402 and multicasts the broadcast television program, or a copy thereof, to the IPTV module in the destination MARS 406, 408, and 410. The IPTV module in the destination MARS 406, 408, and 410 multicasts the broadcast television program, or a copy thereof, to the requesting end-point devices 412, 414, 416, 418, 420, 422, 424, 426, and/or 428.

For some embodiments, each destination MARS 406, 408, and 410 may be coupled to a network IP router (not shown).

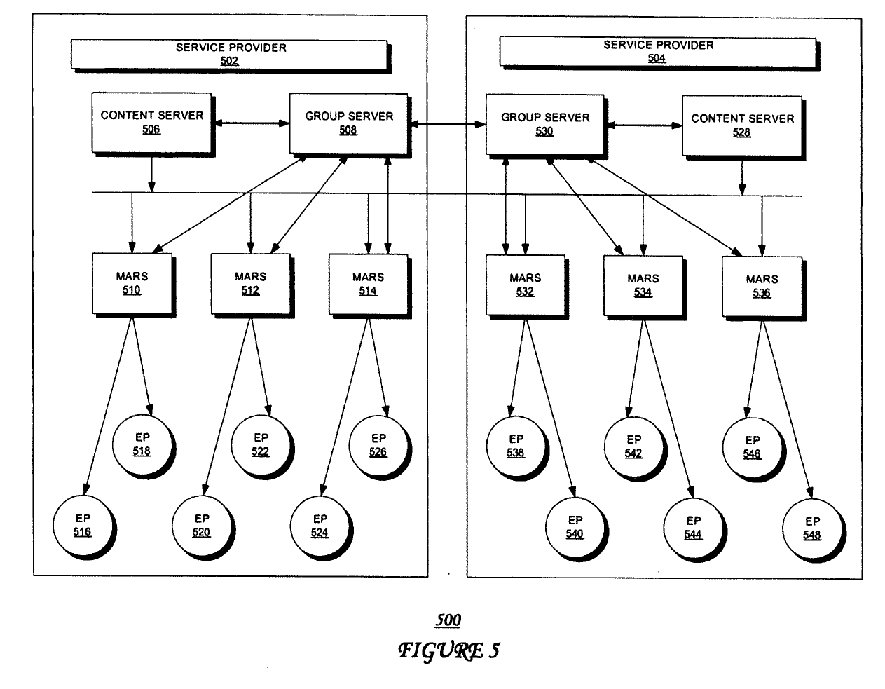

FIG. 5 is a is a simplified block diagram of a portion 500 of the IPTV system 100 according to an embodiment of the present invention in which a user serviced by one service provider can have delivered a broadcast television program offered by another service provider. The illustrated example shows a service provider 502 and a service provider 504.

The service provider 502 is associated with a content server 506, which is coupled to a group server 508. The group server 508 is coupled to three MARS 510, 512, and 514. The MARS 510 is coupled to two end-point devices 516 and 518, the MARS 512 is coupled to two end-point devices 520 and 522, and the MARS 514 is coupled to two end-point devices 524 and 526.

The service provider 504 is associated with a content server 528, which is coupled to a group server 530. The group server 530 is coupled to three MARS 532, 534, and 536. The MARS 532 is coupled to two end-point devices 538 and 540, the MARS 534 is coupled to two end-point devices 542 and 544, and the MARS 536 is coupled to two end-point devices 546 and 548.

For some embodiments, the portion 500 of the IPTV system 100 operates as follows. The content server 506 provides a listing of broadcast television programs available from the service provider 502 to the group server 508, which provides the listing to the MARS 510, 512, and 514. The group server 508 also provides the listing to the group server 530, which provides the listing to the MARS 532, 534, and 536. A user at end-point device 538, 540, 542, 544, 546, and/or 548 may request that a broadcast television program available from the service provider 502 be delivered to them. The content server 506 sends the broadcast television program, or a copy thereof, to the MARS units 532, 534, and/or 536. The MARS units 532, 534, and/or 536 then multicast the broadcast television program, or a copy thereof, to the requesting end-point device 538, 540, 542, 544, 546, and/or 548.

Of course, the portion 500 can operate substantially in reverse. For example a user serviced by the service provider 502 can have delivered a broadcast television program offered by the service provider 504.

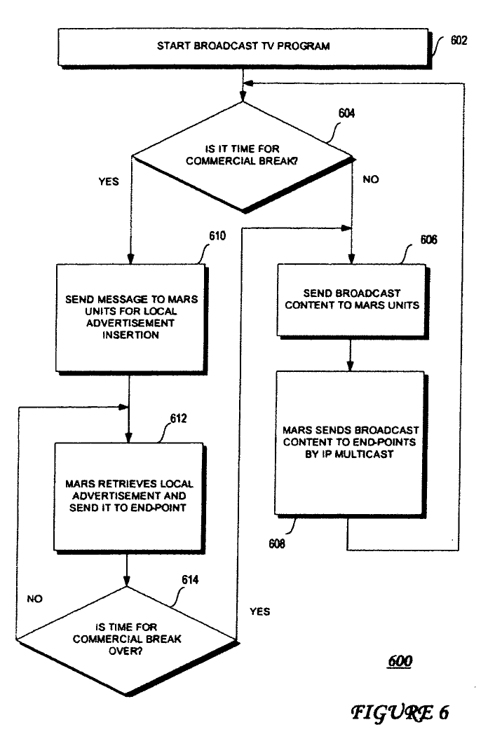

For some embodiments, advertisements may be inserted into the broadcast of the television program. FIG. 6 is a flowchart illustrating a process 600 for inserting advertisements, such as local advertisements, for example, into a broadcast of a television program according to an embodiment of the present invention.

In a block 602, an IPTV module in the destination MARS begins a broadcast television program.

In a block 604, the IPTV modules in the MARS determine whether it is time for an advertisement to be aired. For some embodiments, the central media streaming server 108 controls the starting time and the length of the break. The central media streaming server 108 sends a message to each MARS to inform the MARS of start and stop times, the length, and the storage location of the local advertisement content. Local advertisements may be loaded into the local network storage 138 and/or 139.

If it is determined that it is not time for a commercial to be aired, then in a block 606 the central media streaming server 108 continues sending the broadcast television program to the MARS.

In a block 608, the IPTV module in the MARS multicasts the broadcast television program to its associated end-point devices that have requested the broadcast television program.

If in the block 604 it is determined that is time for a commercial to be aired, control passes to a block 610 in which the central media streaming server 108 sends a message to all associated MARS to insert the specified advertisement.

In a block 612, the MARS retrieves the advertisement from the specified storage location and sends the advertisement to all associated end-point devices.

In a block 614, the IPTV module in the MARS determines whether the stop time for the advertisement has been reached and the break in the broadcast television program is over. If the MARS determines that the stop time for the advertisement has been reached and the break in the broadcast television program is over, then control returns to the block 606. If the MARS determines that the stop time for the advertisement has not been reached and the break in the broadcast television program is not over, then control returns to the block 612.

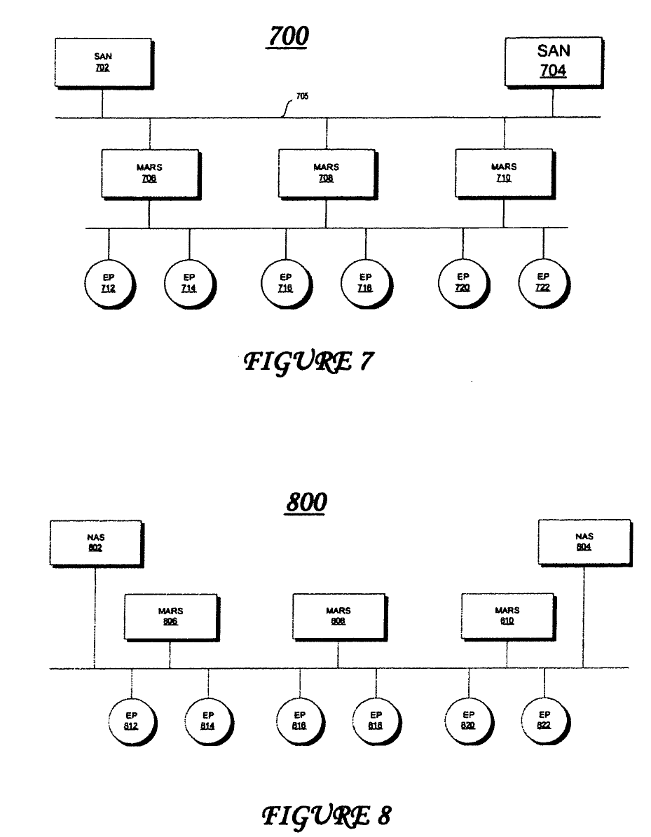

FIGS. 7 and 8 are simplified block diagrams of a portion 700 and 800, respectively, of the IPTV system 100 according to an embodiment of the present invention in which a user can time-shift a broadcast television program. In the portion 700, two storage area network (SAN) devices 702 and 704 are coupled to three MARS 706, 708, and 710 via one sub-network. The MARS 706, 708, and 710 are coupled to six end-point devices 712, 714, 716, 718, 720, and 722 via a second sub-network. The example portion 800 include two network attached storage (NAS) devices 802 and 804, three MARS 806, 808, and 810, and six end-point devices 812, 814, 816, 818, 820, and 822 coupled together via a shared network.

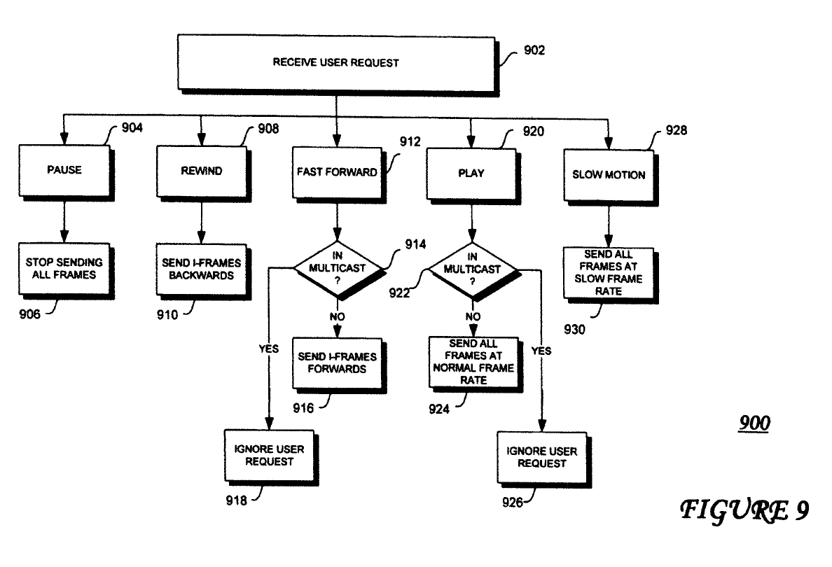

FIG. 9 is a flowchart illustrating a process 900 for time-shifting a broadcast television program according to an embodiment of the present invention. The broadcast television program includes intraframes (or I-frames), predictive frames, and bidirectional frames.

In a block 902, a MARS receives a request from the end-point device.

In a block 904, if the request is to PAUSE the broadcast television program, then in a block 906 the IPTV module in the MARS stops sending all frames of the broadcast television program.

In a block 908, if the request is to REWIND the broadcast television program, then in a block 910 the IPTV module in the MARS sends intraframes of the broadcast television program in a backward sequence.

In a block 912, if the request is to FAST FORWARD the broadcast television program, then in a block 914, the IPTV module in the MARS determines whether the MARS is currently multicasting a broadcast television program. If the MARS is not multicasting a broadcast television program, then in a block 916 the IPTV module in the MARS sends intraframes of the broadcast television program in a forward sequence. If the MARS is multicasting a broadcast television program, then in a block 918 the IPTV module in the MARS ignores the user request to FAST FORWARD the broadcast television program.

In a block 920, if the request is to PLAY the broadcast television program, then in a block 922, the IPTV module in the MARS determines whether the MARS is currently multicasting a broadcast television program. If the MARS is not multicasting a broadcast television program, then in a block 924 the IPTV module in the MARS sends all frames (i.e., intraframes, predictive frames, and bidirectional frames) of the broadcast television program in a forward sequence at a normal frame rate, A normal frame rate may be twenty-five frames per second, thirty frames per second, fifty frames per second, or sixty frames per second, depending on what the frame rate of the broadcast television program is]. If the MARS is multicasting a broadcast television program, then in a block 926 the IPTV module in the MARS ignores the user request to PLAY the broadcast television program.

In a block 928, if the request is to play a broadcast television program in SLOW MOTION, then in a block 930 the IPTV module in the MARS sends all frames (i.e., intraframes, predictive frames, and bidirectional frames) of the broadcast television program in a forward sequence at a slower frame rate than the normal frame rate. For some embodiments, the frame rate may be adjusted by the user.

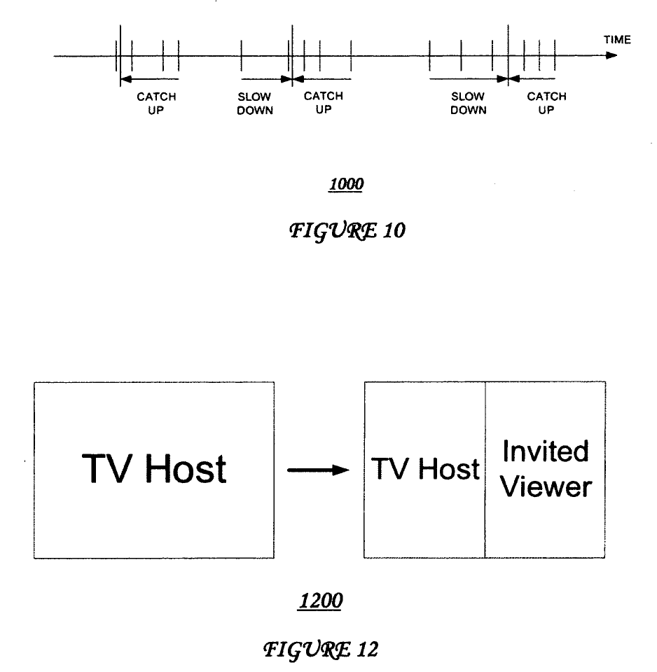

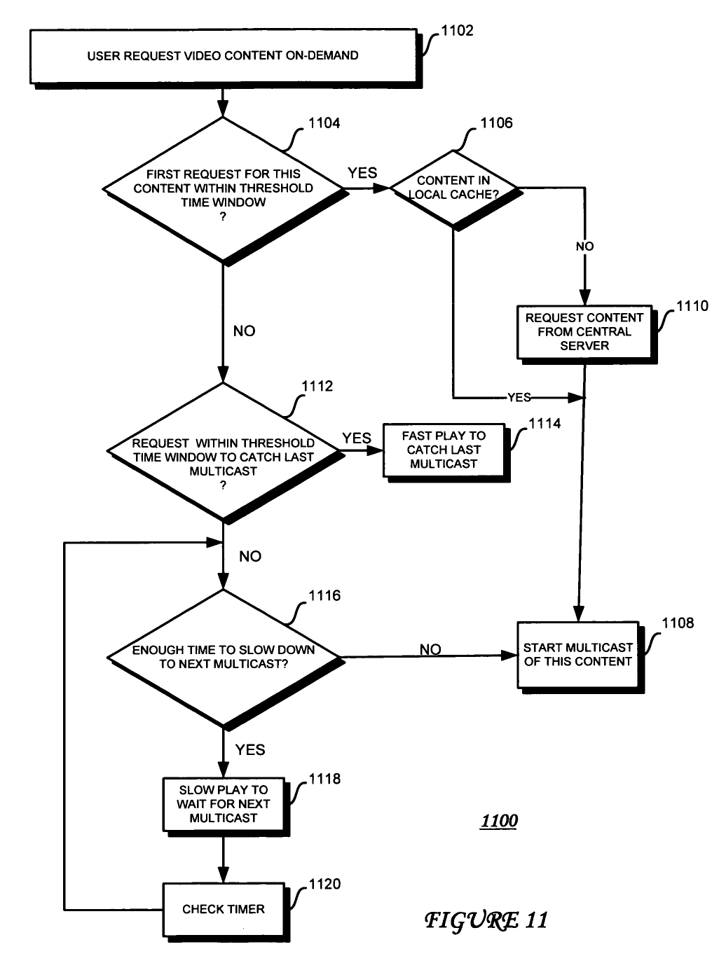

FIG. 10 is a graphical representation 1000 illustrating scalable video on-demand according to an embodiment of the present invention. The graphical representation 1000 illustrates the process of dynamically deciding whether to use multicast or unicast to implement scalable video on-demand. FIG. 10 is described with reference to FIG. 11, which is a flowchart illustrating a process 1100 for operating the example IPTV system 100 according to an embodiment of the present invention.

In a block 1102, a user makes an on-demand request for video content.

In a block 1104, the IPTV module in the MARS determines whether the request is the first request for the video content within a predetermined window of time. For some embodiments, the predetermined window of time may be defined as a time window from a moment prior to the current time up to the current time. The length of the time window may depend on the length of the requested video content.

If the IPTV module in the MARS determines that the request is the first request for the video content within a predetermined window of time, then the IPTV module in the MARS searches for the video content. For example, in a block 1106 the IPTV module in the MARS determines whether the video content is in the local cache (e.g., network storage devices 138 and/or 139). If the IPTV module in the MARS determines that the video content is in the local cache, then in a block 1108 the IPTV module in the MARS begins multicast of the video content from the local cache to the end-point device associated with the requesting user. If the IPTV module in the MARS determines that the video content is not in the local cache, then in a block 1110 the IPTV module in the MARS requests the video content from the central media streaming server 108 and begins multicast of the video content from the central media streaming server 108 to the end-point device associated with the requesting user.

If the IPTV module in the MARS determines that the request is not the first request for the video content within a predetermined window of time, then in a block 1112 the IPTV module in the MARS determines whether the request for the video content is within a window of time sufficient to catch the last multicast of the video content. If the IPTV module in the MARS determines that the request for the video content is within a window of time sufficient to catch the last multicast of the video content, then in a block 1114 the IPTV module in the MARS will unicast a bit stream of the video content to the end-point device associated with the user at a frame rate that is faster than the normal frame rate and the end-point device associated with the user will join the previous multicast after a short period of catch-up time.

If the IPTV module in the MARS determines that the request for the video content is not within a window of time sufficient to catch the previous multicast of the video content, then in a block 1116 the IPTV module in the MARS determines whether the request for the video content is within a window of time sufficient to wait for the next multicast of the video content. If the IPTV module in the MARS determines that the request for the video content is within a window of time sufficient to wait for the next multicast of the video content, then in a block 1118 the IPTV module in the MARS will unicast a bit stream of the video content to the end-point device associated with the user at a frame rate that is slower than the normal frame rate and the end-point device associated with the user will join the next multicast after a short period of wait time.

If the IPTV module in the MARS determines that the request for the video content is within a window of time sufficient to wait for the next multicast of the video content, then the process 110 returns to the block 1108.

It is to be noted that the time to start the next multicast may not be fixed and may depend on how long ago the first slower unicast began. Therefore, there may be a timer to periodically check whether the first slower play is approaching the time threshold beyond which it will be impossible for the first slower bit stream unicast to join the next multicast. This is indicated by a block 1120. If the first slower bit stream unicast is approaching this time threshold, it is time to start the next multicast and all slower bit stream unicasts will join the multicast after different amounts of time. At that time, the IPTV module in the MARS switches the unicast users to the multicast.

Another feature of embodiments of the present invention is that the interactive nature of the system 100 will allow the creative minds of television programming to explore new dimensions in television contents. For example, for the television programming of the New Year's Eve, television stations commonly have tried to cover as many places as possible. However, they have always been limited by how many reporters and camera crews they have. With the system 100, people may submit video of their New Year's Eve activities to television stations and the television stations may select appropriate video materials to broadcast.

FIG. 12 is a simplified diagram of a television screen layout 1200 illustrating another example of a television show that permits viewer participation according to an alternative embodiment of the present invention. When the television host decides to accept communications from a viewer, the two-way communication is enabled. In this example, when a viewer's video is chosen, the television screen layout 1200 may change from a single host to 2×1 where the viewer may be displayed along with the host on a split screen.

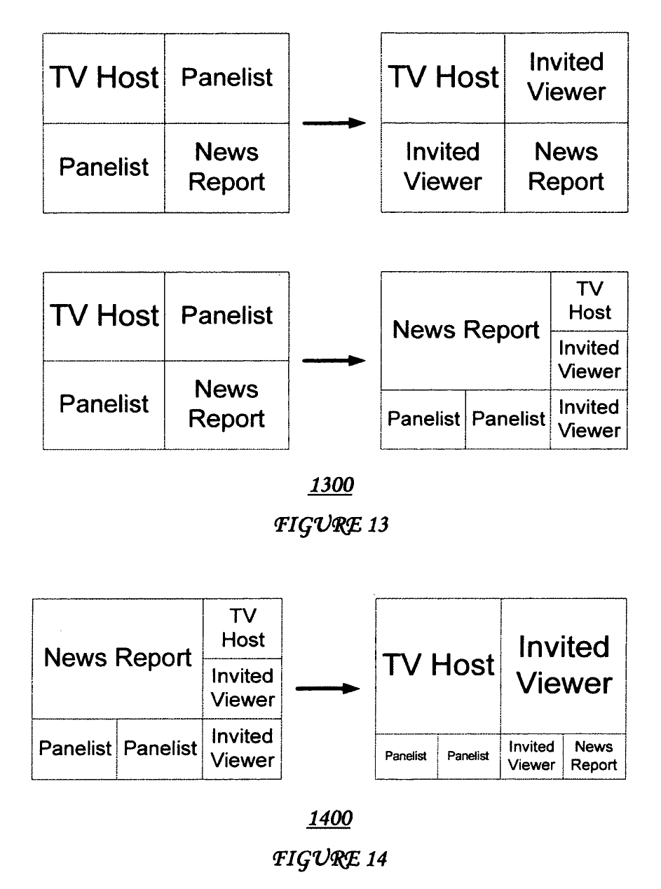

FIG. 13 is a simplified diagram of a television screen layout 1300 illustrating an example of a television show that permits viewer participation according to an alternative embodiment of the present invention. In this example, multiple video scenes are shown in a split screen video layout. The multiple video scenes may include a television host in one of the split screen sub-windows, a news report in another sub-window, and possibly a couple of guests as panelists. For some embodiments, the television host may decide whether to accept communications from the viewers. When a viewer's video is accepted, the viewer's video may replace the content in one of the split screen sub-windows or the video layout may change to add more sub-windows, as illustrated by the difference between the television screen layout 1300 and the television screen layout 1200.

FIG. 14 is a simplified diagram of a television screen layout 1400 illustrating an example of a television show that permits viewer participation according to still another embodiment of the present invention. In this example, a thumbnail may be used to show some of the original video content in a smaller size while the invited viewer's video is shown together with the television host or one of the panelists.

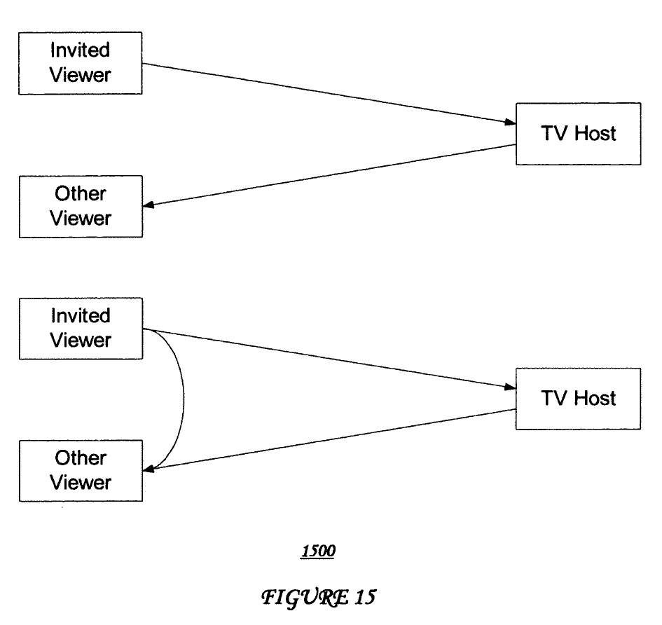

For some embodiments, the system 100 uses a distributed video mixing architecture. For purposes of explanation, consider FIG. 15, which is a simplified diagram 1500 illustrating latency in the system 100 when a viewer is permitted to participate in television show according to an alternative embodiment of the present invention according to an embodiment of the invention. In the top portion of the diagram 1500, the video from the invited viewer takes a certain amount of time to be sent to the TV host. The TV host responds to the invited viewer. The response is mixed with the invited viewer's video and sent to other viewers.

There may be a problem in such a scenario. For example, if the invited viewer is asking a question, the TV host's answer and the invited viewer's question may be mixed in the same video and sent to the other viewers. Without a distributed system architecture, a delay may have to be introduced at the host location, in order to avoid mixing the TV host's answer with the invited viewer's question and having the mixture sent to the other viewers

To solve this problem without introducing too much delay, for some embodiments the video from the invited viewer may be sent to the other viewers at the same time it is sent to the TV host, as shown in the lower portion of diagram 1500. In this scenario, the invited viewer's video may be mixed with the TV host's video locally for the other viewers using the IPTV module in the MARS.

Video mixing may be based on the source time-stamps from one or more invited viewers and the TV host. The source time-stamps may be based on a globally synchronized clock such as network time protocol (NTP) used in the system 100. Any authorized interactive contents from the end-points may be sent from the home MARS to other MARS units and mixed by the destination MARS units for the users they serve.

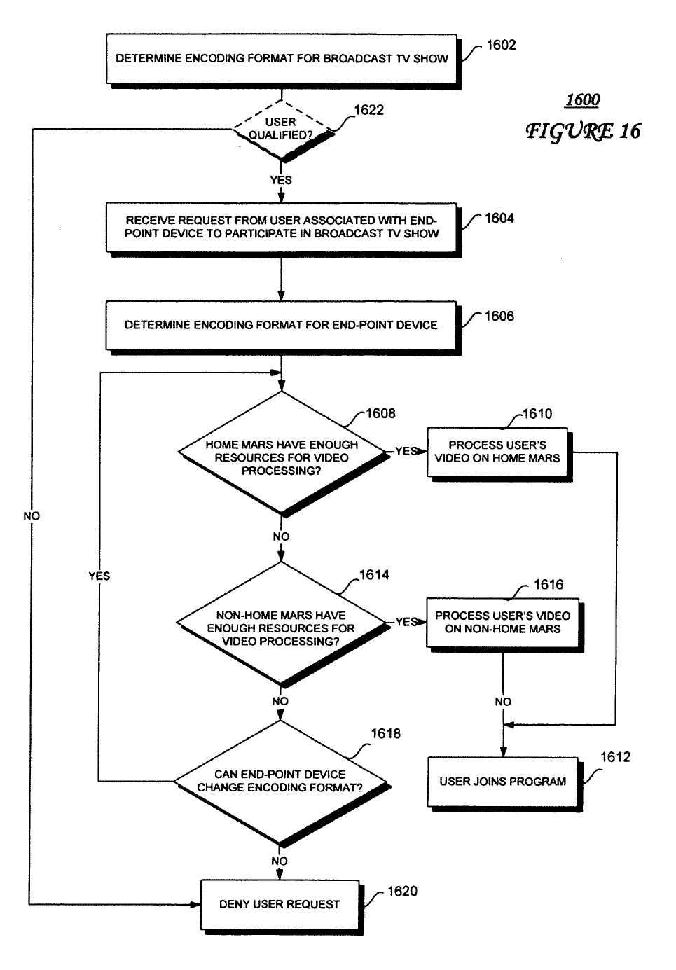

FIG. 16 is a flowchart illustrating a process 1600 for permitting viewer interactivity with a broadcast television program according to an embodiment of the present invention.

In a block 1602, the IPTV module in the MARS determines an encoding format of a television show being broadcast to a user via an associated end-point device.

In a block 1604, the IPTV module in the MARS receives a request from the user via the end-point device to participate in the television show.

In a block 1606, the IPTV module in the MARS determines an encoding format of the end-point device.

In a block 1608, the IPTV module in the MARS determines whether it can process the encoding format of the end-point device to be compatible with the encoding format of the broadcast television program. If the IPTV module in the MARS determines that it can process the encoding format of the end-point device to be compatible with the encoding format of the television show, then in a block 1610 the IPTV module in the MARS processes the encoding format of the end-point device to be compatible with the encoding format of the broadcast television program and in a block 1612 the IPTV module in the MARS permits the end-point device to participate in the broadcast television program. For some embodiments, the IPTV module in the destination or home MARS 206 may transcode the broadcast television program.

If in the block 1608 the IPTV module in the MARS determines that it cannot process the encoding format of the end-point device to be compatible with the encoding format of the television show, then in a block 1614 the IPTV module in the MARS determines whether an IPTV module in a second non-home or intermediate MARS can process the encoding format of the end-point device to be compatible with the encoding format of the broadcast television program. If the IPTV module in the MARS determines that the IPTV module in a second MARS can process the encoding format of the end-point device to be compatible with the encoding format of the broadcast television program, then in a block 1616, the IPTV module in a second MARS processes the encoding format of the end-point device to be compatible with the encoding format of the broadcast television program and the user joins the broadcast television program and in the block 1612 the IPTV module in the home MARS permits the end-point device to participate in the broadcast television program. For some embodiments, the IPTV module in the MARS 206 may transcode the broadcast television program.

If the IPTV module in the MARS determines that the IPTV module in a second MARS cannot process the encoding format of the end-point device to be compatible with the encoding format of the television show, then in a block 1618 the IPTV module in the MARS determines whether the end-point device can change its encoding format to a new encoding format. If the end-point device can change its encoding format to a new encoding format, the process 1100 returns to the block 1608.

If the end-point device cannot change its encoding format to a new encoding format, the process 1600 passes to a block 1620 and the user's request to participate in the broadcast television program is denied.

There is an optional block 1622 that determines whether a user is qualified to participate in the broadcast television program. For some embodiments, a host at the broadcast television program determines whether the user is qualified.

Embodiments of the present invention may be implemented using hardware, software, or a combination thereof. In implementations using software, the software may be stored on a machine-accessible medium.

A machine-accessible medium includes any mechanism that may be adapted to store and/or send information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “for one embodiment” or “in an embodiment” in various places throughout this specification does not necessarily mean that the phrases all refer to the same embodiment. The particular features, structures, or characteristics may be combined in any suitable manner in one or more embodiments.

In practice, the methods described herein may constitute one or more programs made up of machine-executable instructions. Describing the method with reference to the flow charts enables one skilled in the art to develop such programs, including such instructions to carry out the operations (acts) represented by the logical blocks on suitably configured computer or other types of processing machines (the processor of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems.

In addition, embodiments of the invention are not limited to any particular programming language. A variety of programming languages may be used to implement embodiments of the invention.

Furthermore, it is common in the art to speak of software, in one form or another (i.e., program, procedure, process, application, module, logic, etc.), as taking an action or causing a result. Such expressions are merely a shorthand way of saying that execution of the software by a machine caused the processor of the machine to perform an action or produce a result. More or fewer processes may be incorporated into the methods illustrated without departing from the scope of the invention and that no particular order is implied by the arrangement of blocks shown and described herein.

Embodiments of the invention have been described. It will, however, be evident that various modifications and changes may be made thereto without departing from the broader spirit and scope of the invention. The specification and drawings are, accordingly, to be regarded in an illustrative rather than a restrictive sense.

What is claimed is:

1. A system for delivering television over an Internet Protocol (IP) network, the system comprising:
a source real-time routing server or a group server to provide a listing of broadcast television program content available from a source; and
at least one destination real-time routing server to receive a request from at least one end-point device to have a broadcast television program delivered to the end-point device,
wherein the source real-time routing server is to unicast the requested broadcast television program to the at least one destination real-time routing server,
wherein the at least one destination real-time routing server is to multicast the requested broadcast television program to the at least one end-point device.

2. The system of claim 1, wherein the at least one destination real-time routing server is to determine whether the requested broadcast television program is to be transcoded and wherein the at least one destination real-time routing server is to transcode the requested broadcast television program if the at least one destination real-time routing server determines that the requested broadcast television program is to be transcoded.

3. The system of claim 2, wherein the at least one destination real-time routing server is to determine whether at least one end-point device is tuned to a broadcast television program and wherein the at least one destination real-time routing server is to terminate the multicast of the requested broadcast television program if there is not at least one end-point device tuned to a broadcast television program.

4. The system of claim 1, wherein the at least one destination real-time routing server is to multicast the requested broadcast television program to the at least one end-point device using at least one Class-D IP address.

5. The system of claim 1, wherein the source real-time routing server is further to receive at least one message indicating a length of an advertisement and a storage location for the advertisement.

6. The system of claim 5, wherein the source real-time routing server is further to retrieve the advertisement from the storage location and store advertisement at the source real-time routing server.

7. The system of claim 6, wherein the source real-time routing server is further to receive at least a second message indicating a time to deliver the advertisement to end-point devices.

8. The system of claim 7, wherein the source real-time routing server is further to send the advertisement to the at least one end-point device at time indicated in the at least one second message.

9. A system for delivering television over an Internet Protocol (IP) network, the system comprising:
a source real-time routing server or a group server to provide a listing of broadcast television program content available from a source; and
a set of destination real-time routing servers having:
a first destination real-time routing server to receive a first request to have a broadcast television program in the listing of broadcast television program content delivered to a first set of end-point devices; and
a second destination real-time routing server to receive a second request to have the broadcast television program in the listing of broadcast television program content delivered to a second set of end-point devices,
wherein the source real-time routing server is to multicast the requested broadcast television program to the set of destination real-time routing servers,
wherein the first and the second destination real-time routing servers are to multicast the requested broadcast television program to the first and the second sets of end-point devices, respectively.

10. The system of claim 9, further comprising a first network IP router, wherein the source real-time routing server is further to multicast the requested broadcast television program to the first network IP router and the first network IP router is multicast the requested broadcast television program to the first real-time routing server.

11. The system of claim 10, further comprising a second network IP router, wherein the source real-time routing server is further to multicast the requested broadcast television program to the second network IP router and the second network IP router is multicast the requested broadcast television program to the second real-time routing server.

12. A system for delivering television over an Internet Protocol (IP) network, the system comprising:
a first group server associated with a first service provider;
a first content server associated with a first service provider;
a second group server associated with a second service provider; and
a second content server associated with a second service provider; and
a real-time routing server to provide a listing of broadcast television program content available from the second service provider to at least one end-point device serviced by the first service provider and to send a request to the first group server to have a broadcast television program delivered to the at least one end-point device,
wherein the second content server is to send the requested broadcast television program to the real-time routing server, and wherein the real-time routing server is to multicast the broadcast television program to the at least one end-point device.

13. The system of claim 12, further comprising a second real-time routing server to provide a second listing of broadcast television program content available from the first service provider to at least a second end-point device serviced by the second service provider and to send a request to the second group server to have a second broadcast television program delivered to the at least the second end-point device.

14. The system of claim 13, wherein the first content server is to send the second requested broadcast television program to the second real-time routing server.

15. The system of claim 14, wherein the second real-time routing server is to multicast the second requested broadcast television program to the at least the second end-point device.

16. A system for delivering television over an Internet Protocol (IP) network, the system comprising:
a storage device to store a broadcast television program, the broadcast television program having a series of intraframes, predictive frames, and bidirectional frames; and
a real-time routing server to receive a request from at least one end-point device to have the broadcast television program delivered to the end-point device, the real-time routing server to retrieve the broadcast television program from the storage device and to send the broadcast television program to the end-point device, the real-time routing server further to receive a request from the at least one end-point device to PAUSE the broadcast television program, wherein the real-time routing server is to terminate sending the broadcast television program to the end-point device in response to the request from the at least one end-point device to PAUSE the broadcast television program.

17. The system of claim 16, wherein the storage device is a storage area network (SAN) device.

18. The system of claim 16, wherein the storage device is a network attached storage (NAS) device.

19. A system for delivering television over an Internet Protocol (IP) network, the system comprising:
a storage device to store a broadcast television program, the broadcast television program having a series of intraframes, predictive frames, and bidirectional frames; and
a real-time routing server to receive a request from at least one end-point device to have the broadcast television program delivered to the end-point device, the real-time routing server to retrieve the broadcast television program from the storage device and to send the broadcast television program to the end-point device, the real-time routing server further to receive a request from the at least one end-point device to REWIND the broadcast television program, wherein the real-time routing server is to send intraframes in a backward sequence to the end-point device.

20. The system of claim 19, wherein the storage device is a storage area network (SAN) device.

21. The system of claim 19, wherein the storage device is a network attached storage (NAS) device.

22. A system for delivering television over an Internet Protocol (IP) network, the system comprising:
a storage device to store a broadcast television program, the broadcast television program having a series of intraframes, predictive frames, and bidirectional frames; and
a real-time routing server to receive a request from at least one end-point device to have the broadcast television program delivered to the end-point device, the real-time routing server to retrieve the broadcast television program from the storage device and to send the broadcast television program to the end-point device, the real-time routing server further to receive a request from the at least one end-point device to FAST FORWARD the broadcast television program, wherein the real-time routing server is to determine whether the real-time routing server is multicasting the broadcast television program to the end-point device in response to the request to FAST FORWARD the broadcast television program.

23. The system of claim 22, wherein if the real-time routing server is multicasting the broadcast television program to the end-point device, then the real-time routing server is to ignore the request to FAST FORWARD the broadcast television program.

24. The system of claim 22, wherein if the real-time routing server is not multicasting the broadcast television program to the end-point device, then the real-time routing server is to send intraframes in a forward sequence to the end-point device.

25. A system for delivering television over an Internet Protocol (IP) network, the system comprising:
a storage device to store a broadcast television program, the broadcast television program having a series of intraframes, predictive frames, and bidirectional frames; and
a real-time routing server to receive a request from at least one end-point device to have the broadcast television program delivered to the end-point device, the real-time routing server to retrieve the broadcast television program from the storage device and to send the broadcast television program to the end-point device, the real-time routing server further to receive a request from the at least one end-point device to PLAY the broadcast television program, wherein the real-time routing server is to determine whether the real-time routing server is multicasting the broadcast television program to the end-point device in response to the request to PLAY the broadcast television program.

26. The system of claim 25, wherein if the real-time routing server is multicasting the broadcast television program to the end-point device, then the real-time routing server is to ignore the request to PLAY the broadcast television program.

27. The system of claim 25, wherein if the real-time routing server is not multicasting the broadcast television program to the end-point device, then the real-time routing server is to send intraframes, predictive frames, and bidirectional frames in a forward sequence to the end-point device.

28. A system for delivering television over an Internet Protocol (IP) network, the system comprising:
a storage device to store a broadcast television program, the broadcast television program having a series of intraframes, predictive frames, and bidirectional frames; and
a real-time routing server to receive a request from at least one end-point device to have the broadcast television program delivered to the end-point device, the real-time routing server to retrieve the broadcast television program from the storage device and to send the broadcast television program to the end-point device, the real-time routing server further to receive a request from the at least one end-point device to deliver the broadcast television program in SLOW MOTION, wherein the real-time routing server is to send intraframes, predictive frames, and bidirectional frames to the end-point device at a speed slower than in response to the request to deliver the broadcast television program in SLOW MOTION.

29. The system of claim 28, wherein the real-time routing server is further to receive a second request from the at least one end-point device to REWIND the broadcast television program and wherein the real-time routing server is to send intraframes in a backward sequence to the end-point device in response to the request to REWIND the broadcast television program.

30. The system of claim 28, wherein the storage device is a storage area network (SAN) device.

31. The system of claim 28, wherein the storage device is a network attached storage (NAS) device.

32. A method for delivering television over an Internet Protocol (IP) network, the system comprising:
determining whether a request from at least one end-point device to have media content delivered to the end-point device is a first request for the media content, the media content being designated for on-demand access,
if the request for the media content is the first request for the media content, then multicasting the media content to the end-point device;
if the request for the media content is not the first request for the media content, then determining whether the end-point device can join an in-progress multicast of a copy of the media content; and
if the end-point device can join an in-progress multicast of the media content, then unicasting a second copy of the media content to the end-point device at a first frame rate that is fast enough to allow the second copy of the media content to synchronize with the in-progress multicast of the media content at or before a predetermined point in the multicast.

33. The method of claim 32, further comprising if the request for the media content is a first request for the media content, then determining whether the media content is stored in a local storage.

34. The method of claim 33, further comprising if the media content is stored in a local storage, then multicasting the requested media content to the at least one end-point device.

35. The method of claim 33, further comprising if the media content is not stored in a local storage, then retrieving the media content from a remote storage and multicasting the requested media content to the at least one end-point device.

36. A method for delivering television over an Internet Protocol (IP) network, the system comprising:
determining whether a request from at least one end-point device to have media content delivered to the end-point device is a first request for the media content, the media content being designated for on-demand access,
if the request for the media content is the first request for the media content, then multicasting the media content to the end-point device;
if the request for the media content is not the first request for the media content, then determining whether the end-point device can join a multicast of a copy of the media content to be started in the future;
if the end-point device can join a multicast of the media content to be started in the future, then unicasting a second copy of the media content to the end-point device at a second frame rate that slower than the frame rate of the next multicast to be started in the future.

37. The method of claim 36, further comprising that the end-point device cannot join a multicast of the media content if the multicast does not start right away, then start a multicast of the media content.

38. The method of claim 37, further comprising synchronizing the slow play unicast with the upcoming multicast of the media content, wherein the unicast is to switch to the multicast after a period of time from starting the multicast.

39. A method for delivering television over an Internet Protocol (IP) network, the method comprising:
determining an encoding format of a television show;
receiving a request from an end-point device to participate in the television show;
determining an encoding format of the end-point device;
determining whether a first real-time routing server is suitable for processing the encoding format of the end-point device to be compatible with the encoding format of the television show;
if the first real-time routing server is suitable for processing the encoding format of the end-point device to be compatible with the encoding format of the television show, then:
processing the encoding format of the end-point device to be compatible with the encoding format of the television show; and
permitting the end-point device to participate in the television show.

40. The method of claim 39, further comprising if the first real-time routing server is not suitable for processing the encoding format of the end-point device to be compatible with the encoding format of the television show, then determining whether a second real-time routing server is suitable for processing the encoding format of the end-point device to be compatible with the encoding format of the television show.

41. The method of claim 40, further comprising if the second real-time routing server is suitable for processing the encoding format of the end-point device to be compatible with the encoding format of the television show, then:
permitting the processing the encoding format of the end-point device to be compatible with the encoding format of the television show to be performed at the second real-time routing sever; and
permitting the end-point device to participate in the television show.

42. The method of claim 40, further comprising if the second real-time routing server is not suitable for processing the encoding format of the end-point device to be compatible with the encoding format of the television show, then determining whether the end-point device can change its encoding format to a new encoding format.

43. The method of claim 42, further comprising if the end-point device can change its encoding format to a new encoding format, then:
determining the new encoding format of the end-point device;
if the first real-time routing server is suitable for processing the new encoding format of the end-point device to be compatible with the encoding format of the television show, then permitting the processing the new encoding format of the end-point device to be compatible with the encoding format of the television show to be performed at the first real-time routing sever; and
if the first real-time routing server is not suitable for processing the new encoding format of the end-point device to be compatible with the encoding format of the television show, but the second real-time routing server is suitable for processing the new encoding format of the end-point device to be compatible with the encoding format of the television show, then permitting the processing the encoding format of the end-point device to be compatible with the encoding format of the television show to be performed at the second real-time routing sever.

44. The method of claim 42, further comprising if the end-point device cannot change its encoding format to a new encoding format, then denying the request for the end-point device to participate in the television show.
